(19) United States
(12) Patent Application Publication
(10) Pub. No.: US 2026/0039041 A1
(43) Pub. Date: Feb. 5, 2026

(54) CONNECTION ARRANGEMENT AND METHOD FOR FORMING A CONNECTION ARRANGEMENT

(71) Applicant: Robert Bosch GmbH, Stuttgart (DE)

(72) Inventor: Oliver Schilli, Lichtenstein (DE)

(21) Appl. No.: 19/101,440

(22) PCT Filed: Sep. 27, 2023
(86) PCT No.: PCT/EP2023/076764

§ 371 Date: Feb. 5, 2025

(30) Foreign Application Priority Data
Sep. 28, 2022 (DE) 10 2022 210 287.8

(51) Int. Cl. H01R 12/58; H01R 43/16

(52) U.S. Cl. CPC H01R 12/585; H01R 43/16

(57) ABSTRACT

A press-in contact element. The press-in contact element includes at least two press-in zones which are each formed at the end of an edge contour of the press-in contact element along respectively parallel extending and spaced apart press-in axes. The at least two press-in zones also have a galvanic coating and a spacing distance from one another in the direction of the press-in axes. In each case then, at least two press-in zones are formed on partial contact elements that are connected to one another in a connection interface to form the press-in contact element.

### FIELD

The present invention relates to a press-in contact element, a method for its production, and a sheet metal part composite for use in the method.

### BACKGROUND INFORMATION

Press-in technology is a conventional and reliable connection technique for establishing electrical and/or mechanical contact between connection partners. Electrical devices comprise press-in pins, for example, by means of which electrical components or assemblies, for instance, are brought into electrical contact with a circuit carrier. In order to obtain a qualitatively reliable press-in contact, the press-in pin has to have a press-in zone which can be pressed into a complementary recess in the circuit carrier under defined conditions. Among other things, defined conditions include in particular the geometrical mating dimensions and mating materials of the connection partners in the region of the press-in contact to be created. The press-in pins in the region of the press-in zone therefore have a coating that is made of a suitable material and has a tolerated outer dimension. The coating is applied by means of a galvanic process, for instance, in which such press-in pins can be manufactured automatically in large quantities while being held in a strip material by continuously moving the strip material past underneath a coating device.

Also conventional are press-in contact elements comprising a plurality of press-in zones; for example to bring a plurality of circuit carriers disposed one above the another into electrical contact. The press-in zones have to then to be at different heights. Due to the height offset of the press-in zones, however, the required layer thicknesses of the galvanic coating cannot be guaranteed for production reasons. It has therefore so far been necessary to punch out such press-in contact elements with the press-in zones at the same height and then bring them to the correct height later with complex bending. This reduces the achievable tolerance of a position of the press-in zones, however, and also makes the press-in contact element expensive.

Connecting very complex sheet metal parts to one another by welding is generally conventional. The sheet metal connection parts are aligned using appropriate alignment geometries.

### SUMMARY

An object of the present invention is to provide a press-in contact element comprising a plurality of press-in zones disposed at different heights with minimized tolerances and at low cost.

This object may be achieved by a press-in contact element, a method for its production, and by a sheet metal part composite for use in the method having certain features of the present invention.

The present invention relates to a press-in contact element. According to an example embodiment of the present invention, the press-in contact element includes at least two press-in zones which are each formed at the end of an edge contour of the press-in contact element along respectively parallel extending and spaced apart press-in axes. The at least two press-in zones also have a galvanic coating and a spacing distance from one another in the direction of the press-in axes. In each case then, at least two press-in zones are formed on partial contact elements that are connected to one another in a connection interface to form the press-in contact element. The partial contact elements can advantageously be produced in advance with an optimum galvanic coating, at least in the region of their press-in zones, regardless of their final arrangement within the press-in contact element. Only after the galvanic process is completed is the geometric arrangement of the already galvanically coated press-in zones of different partial contact elements formed using a simple connection technique with small tolerances for a position. The costs for such a press-in contact element can advantageously be favorably reduced in mass or series production.

These advantages pay off in particular when the vertical spacings of the press-in zones are large. Implementation in the described manner is therefore preferred with a spacing distance of more than 7 mm, in particular more than 10 mm, for example more than 15 mm.

Advantageous further developments and improvements of the press-in contact element according to the present invention are made possible by the measures disclosed herein.

An advantageous example embodiment of the press-in contact element provides that the connection interface comprises a material connection, a frictional connection and/or a form-locking connection. The form-locking connection is advantageous for correct alignment of the partial contact elements to one another, while the frictional connection and/or the material connection holds the partial contact elements together in the correct alignment position, in particular permanently, as the press-in contact element. Overall, this makes it possible to also create a very rigid press-in contact element if needed, so that simultaneous or sequential press-fitting of the press-in zones arranged with a vertical spacing can take place without yielding during press-fitting. This applies in particular to a favorable design of the press-in contact element in which, in particular in the region of the connection interface, the interconnected partial contact elements are disposed within the same layer plane.

Particular advantages are obtained with an example embodiment of the press-in contact element of the present invention if the partial contact elements are each configured as punched sheet metal parts or laser sheet metal parts and the press-in contact element extends within the same base sheet metal plane of the partial contact elements. The partial contact elements can thus be manufactured on conventional sheet metal processing systems, for example punching systems or laser systems, in particular in a highly automated and precise manner. The press-in zones can moreover also be manufactured with high precision using proven embossing processes. Lastly, the sheet metal material can be provided in the form of strip material. Intermediate product states of partial contact elements within a formed sheet metal part composite made from the strip material can thus be produced in a highly automated manner, even with respect to galvanically coating at least the press-in zones, and with the ability to very precisely adjust the layer thicknesses.

In a preferred further development of the press-in contact element of the present invention, the partial contact elements have complementarily configured outer contour profiles in the region of the connection interface. The complementarily configured outer contour profiles are fitted together in an interlocking manner like a puzzle, which creates at least one form-locking connection and/or frictional connection. This enables correct positioning of the partial contact elements to one another and also simple connection of said elements to one another. A large number of possible complementary outer contour profiles are possible, which can be implemented for the stated purposes depending on the application.

In another advantageous embodiment of the press-in contact element of the present invention, at least one of the partial contact elements comprises at least one further press-in zone. All of the press-in zones of the at least one partial contact element are then disposed on the same layer plane which is oriented perpendicular to the press-in axes. The further press-in zones make it possible to bring a plurality of different required contact points, for example of an electronic circuit disposed on a circuit carrier, into electrical contact with one press-in process. Multiple contacting can also ensure a current carrying capacity and/or mechanical stabilization, for instance.

The present invention also leads to a method for manufacturing a press-in contact element, in particular according to at least one of the above-described embodiments. According to an example embodiment of the present invention, the method includes at least the following method steps:
a) forming at least two partial contact elements with different contours from a base material, each comprising at least one press-in zone,
b) applying a galvanic coating at least in the region of the at least one press-in zone of the at least two partial contact elements,
c) connecting the at least two partial contact elements in the region of a connection interface to create the press-in contact element such that the respective at least one press-in zones formed on the at least two partial contact elements with different contours are disposed on a parallel press-in axis and in the direction of the press-in axes with a spacing distance from one another.

An advantage of a press-in contact element produced in this way is that, despite a height offset of the included press-in zones, a layer thickness of the galvanic coating applied to it can be ensured with a high accuracy included. This also ensures that the press-in conditions are the same for all of the press-in zones, which makes it possible to maintain high process reliability. It also makes it possible to maintain the required position of the press-in zones with very low tolerances. The partial contact elements are in particular made of a strip and/or sheet metal material. Their contour profiles can be produced precisely in a simple manner, in particular by means of a cutting process, for example a punching process or a laser process. The press-in zones can also be formed with great precision, in particular using conventional embossing processes, in particular with proven press-in geometries.

A particularly great advantage is obtained in an example embodiment of the method of the present invention in which, in method step a), a plurality of the at least two partial contact elements with different contours are formed in a common continuous strip and/or sheet metal material as a sheet metal part composite. Each of the partial contact elements is held in the sheet metal part composite via at least one sheet metal web made of the strip and/or sheet metal material. Each partial contact element is singulated only after method step b) and before method step c) by severing the at least one sheet metal web. This makes it easy to use conventional galvanic process systems that apply the coating to sheet metal strips in the described form in order to achieve the highest possible number of pieces. In this respect, an adaptation of the method is particularly advantageous in that the press-in zones of the plurality of the at least two partial contact elements with different contours included in the sheet metal part composite are formed such that they are disposed in a common coating region in the direction of the strip path of the continuous strip and/or sheet metal material. The galvanic coating is then applied in method step b) by means of a coating device during a relative, in particular continuous, movement of the sheet metal part composite and the coating device to one another in the common coating region. This results in the same coating conditions for each formed press-in zone of each partial contact element over the course of production.

For the purpose of a positionally correct and fixed connection, in a preferred embodiment of the method of the present invention it is provided that, in method step a), the at least two partial contact elements with different contours are formed over a respective contour section with complementarily configured outer contour profiles. In method step c), the at least two partial contact elements are then fitted together in an interlocking manner like a puzzle in the region of the complementarily configured outer contour profiles to create the connection interface as a form-locking connection and/or a frictional connection.

To ensure an even stronger permanent connection of the partial contact elements, an advantageous example embodiment of the method of the present invention is configured such that the at least two partial contact elements are connected to one another in the region of the connection interface exclusively or additionally by means of a material connection. Such a material connection can take the form of a weld, adhesive or solder connection, for example. The frictional connection can also be achieved by means of caulking or a press fit. A special embodiment of the connection design that also exhibits high rigidity is achieved in particular by disposing the partial contact elements in a common sheet metal plane.

An example embodiment of the present invention also leads to a sheet metal part composite, in particular for use in a method according to at least one of the above-described embodiments. The sheet metal part composite respectively comprises a plurality of at least two partial contact elements with different contours in a common continuous strip and/or sheet metal material. The partial contact elements are then each held in the sheet metal part composite via at least one sheet metal web made of the strip and/or sheet metal material. The partial contact elements also each comprise at least one press-in zone and are disposed within the sheet metal part composite such that the respective at least one press-in zones are disposed one behind the other parallel to an edge of the strip and/or sheet metal material.

In a particularly advantageous example embodiment of the sheet metal part composite of the present invention, sections of the outer contour profile of the respective at least two partial contact elements with different contours are configured complementarily to one another such that, in the singulated state, the at least two partial contact elements with different contours form a press-in contact element in at least one of the above-described embodiments by fitting the complementarily configured outer contour profiles together in an interlocking manner like a puzzle. The partial contact elements are singulated by separating them from the sheet metal part composite at the respective holding sheet metal web.

Great advantages also result from an example embodiment of the sheet metal part composite according to the present invention in which the sheet metal part composite comprises a galvanic coating at least in the region of the press-in zones disposed one behind the other parallel to the one edge of the strip and/or sheet metal material.

In general, the same advantages apply as have already been mentioned in detail for the above-described press-in contact element and the method for producing the press-in contact element.

### BRIEF DESCRIPTION OF THE DRAWINGS

Further advantages, features, and details of the present invention will emerge from the following description of preferred embodiment examples and with reference to the figures.

### BRIEF DESCRIPTION OF THE DRAWINGS

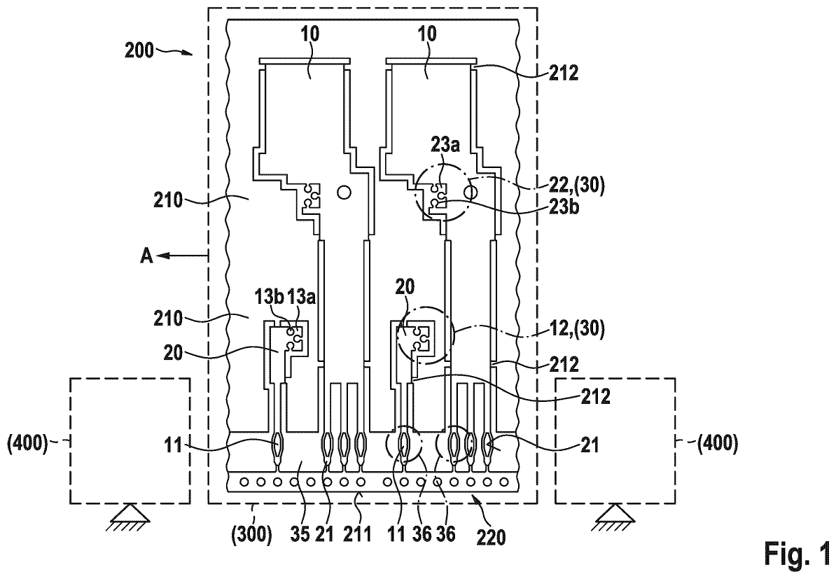

FIG. 1 shows a sheet metal part composite including at least two partial contact elements with different contours during a manufacturing process for a press-in contact element in a plan view, according to an example embodiment of the present invention.

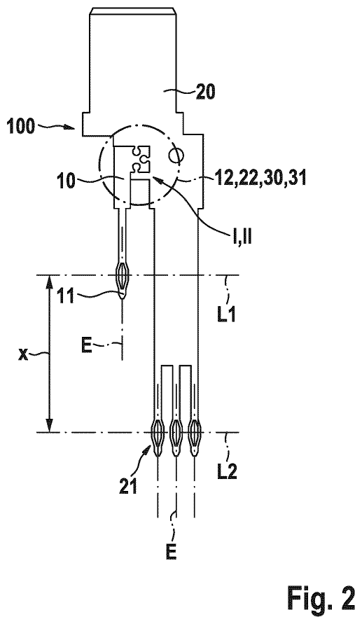

FIG. 2 shows a press-in contact element including two partial contact elements which are connected in a connection interface and each comprise a press-in zone with a galvanic coating in a plan view, according to an example embodiment of the present invention.

### DETAILED DESCRIPTION OF EXAMPLE EMBODIMENTS

In the figures, functionally equivalent components are identified with the same respective reference signs.

FIG. 1 shows a sheet metal part composite 200 comprising at least two partial contact elements 10, 20 with different contours during a manufacturing process for a press-in contact element 100. The base material used for the sheet metal part composite 200 is in particular a metallic strip and/or sheet metal material 210, for example made of copper or a copper alloy. To enable simple conveying of the strip and/or sheet metal material 210 through at least one processing system 300, 400, the strip and/or sheet metal material 210 preferably comprises a conveying structure 220 in the region of a terminal edge 211. The conveying structure 220 can, for instance, be configured as a perforation, in which moving conveying elements of the processing system 300, 400 engage and move the strip and/or sheet metal material 210 continuously or in a clocked manner in a defined conveying direction A. A plurality of at least two partial contact elements 10, 20 with different contours are formed as part of the sheet metal part composite 200, in particular in a highly automated manufacturing process. Each of these partial contact elements 10, 20 comprises at least one, two, three or more press-in zones 11, 21. Such press-in zones 11, 21 are in particular placed using conventional embossing processes to create defined shape geometries (not shown). It is provided that the press-in zones 11, 21 of all of the partial contact elements 10, 20 to be formed are disposed one behind the other in the direction of the strip path A. In the shown embodiment example, the press-in zones 11, 21 are disposed adjacent to one another on a side of the perforation 220 facing away from the terminal edge 211. This also specifies the positional alignment of the respective partial contact elements 10, 20 as such within the strip and/or sheet metal material 210 in relation to its terminal edge 211. The ultimate arrangement of the partial contact elements 10, 20 relative to one another within the strip and/or sheet metal material 210 is carried out depending on the application, preferably with the objective of of manufacturing a product with little waste. This embodiment example shows an alternating sequence of a first partial contact element 10 and a second partial contact element 20 that differs from the first partial contact element 10 in terms of its contour. The second partial contact element 20 is significantly larger than the first partial contact element 10. A surface area of the base material 210 remains between two immediately following second partial contact elements 20, in which the first partial contact element 10 can still be disposed with a sufficient spacing to the respective adjacent second partial contact elements 20. The respective shape contour of the partial contact elements 10, 20 is formed by material removal, for example by a punching or laser process. For mass and/or series production, material removal takes place over different timed subsequent stages. FIG. 1 shows a material removal stage in which each of the partial contact elements 10, 20 is still being held in the sheet metal part composite 200 via at least one sheet metal web 212 made of the strip and/or sheet metal material 210. Such multiple material removal stages can be carried out within the same punching or laser system 300. Depending on the manufacturing, however, individual material removal stages can also be carried out by different systems 300.

The at least two partial contact elements 10, 20 with different contours are formed over a respective contour section with complementarily configured outer contour profiles 12, 22. They fit together precisely to form a joining geometry 30. In a section of its outer contour profile 22, for example, one of the partial contact elements 10, 20 with different contours comprises an inward-facing recess 23a into which still protruding fitting structures 23b project. The other partial contact element 10, 20 with the complementary outer contour profile 12 comprises an outward-projecting surface area 13a that follows the geometry of the aforementioned recess 23a. Inward-facing recess structures 13b, which again correspond to the aforementioned fitting structures 23b in the geometry, are furthermore configured in this surface area 13a. Other matching joining geometries 30 are possible, too, however.

A coating region 35 in the direction of the strip path A is provided in the region of the press-in zones 11, 21 disposed in the sheet metal part composite 200. In this region, a coating system 400 is used to apply in particular a galvanic coating 36 to at least the press-in zones 11, 12. This ensures identical defined press-in conditions for said zones. This can take place at a time of production after only the press-in zones 11, 12 have been formed in the strip and/or sheet metal material 210 by a cutting and an embossing process. Only after the coating has been carried out are the respective contour profiles of the at least two partial contact elements 10, 20 with different contours adjoining the press-in zones 11, 12 formed with the corresponding holding sheet metal webs 212 by the respective material removal. Alternatively, however, it is also possible to apply the coating 36 within the coating region 35 only after the at least two partial contact elements 10, 20 with different contours are formed in the sheet metal part composite 200.

After the partial contact elements 10, 20 have been formed and the coating 36 has been applied to their included press-in zones 11, 12, all of the partial contact elements 10, 20 are singulated from the sheet metal part composite 200. This is done by severing the holding sheet metal webs 212, for example by another punching or laser process.

However, as an alternative to the above-described method up to the singulation of the at least two partial contact elements 10, 20 with different contours, it is also possible to form the at least two partial contact elements 10, 20 with different contours from respective different strip and/or sheet metal materials 210. This then accordingly results in different sheet metal part composites 200 corresponding to the number of partial contact elements 10, 20 with different contours, in each of which only one identical type of partial contact element 10, 20 is manufactured and then singulated.

The at least two partial contact elements 10, 20 with different contours are then connected to one another, to form a press-in contact element 100. Such a press-in contact element 100 is shown in a plan view in FIG. 2. The aforementioned joining geometry 30 then in particular represents a connection interface 31 in which the complementarily configured outer contour profiles 12, 22 are fitted together in an interlocking manner like a puzzle. The connection interface 31 is thus in particular configured as a form-locking connection and/or as a frictional connection I. The form-locking connection I ensures precise positioning of the two partial contact elements 10, 20 relative to one another. A configured frictional connection I on the other hand enables a firm, possibly permanent connection. A frictional connection I can, for instance, also be achieved by caulking or another corresponding method. Alternatively or additionally, a material connection II can be formed within the connection interface 31 to ensure a permanent connection. A welded, soldered or adhesive contact is suitable for this purpose, for example. A material connection II can also be achieved, for instance, by forming the corresponding connection material locally, possibly at specific points, at one or more intended connection points, for example by means of a spot weld that includes the base material of both partial contact elements 10, 20. In the embodiment example, the connection is carried out by disposing the partial contact elements 10, 20 in a common sheet metal plane. In other not depicted embodiments, it is possible to provide an arrangement that is of some other type but follows the same principle.

The press-in contact element 100 shown in FIG. 2 has a total of four press-in zones 11, 21, all of which are formed along respective parallel extending and spaced apart press-in axes E. Three of the press-in zones 21 are disposed on the same layer plane L2 oriented perpendicular to the press-in axes E and are part of the second partial contact element 20. A further press-in zone 11, on the other hand, is part of the first partial contact element 10 and is disposed in a layer plane L1 parallel to L2. The one press-in zone 11 thus has a spacing distance x to the other three press-in zones 21 in the direction of the press-in axes E. Despite the spacing distance x, all of the press-in zones 11, 21, regardless of their affiliation to one of the partial contact elements 10, 20 with different contours, have the same coating characteristics, in particular with respect to the external geometric dimensions and/or the dimensional tolerances of the coating thicknesses. In not depicted embodiments, more than two partial contact elements 10, 20 can form the press-in contact element 100. The respective partial contact elements 10, 20 can furthermore comprise one, two, three or more press-in zones 11, 21 in various combination variants. The spacing distance x can moreover be adapted to the application requirements, in particular with a spacing distance of more than 7 mm, in particular more than 10 mm, for example more than 15 mm. If there are more than two partial contact elements 10, 20, the press-in zones 11, 21 of at least two partial contact elements 10, 20 can have different spacing distances x in the direction of the press-in axes E.

1-15. (canceled)

16. A press-in contact element, comprising:
at least two press-in zones which are each formed at an end of an edge contour of the press-in contact element along respectively parallel extending and spaced apart press-in axes, wherein the at least two press-in zones have a galvanic coating and a spacing distance from one another in a direction of the press-in axes;
wherein the at least two press-in zones are formed on partial contact elements that are connected to one another in a connection interface to form the press-in contact element.

17. The press-in contact element according to claim 16, wherein the spacing distance is more than 7 mm.

18. The press-in contact element according to claim 16, wherein the connection interface includes a material connection and/or a frictional connection and/or a form-locking connection.

19. The press-in contact element according to claim 18, wherein in a region of the connection interface, the partial contact elements include complementarily configured outer contour profiles, wherein the complementarily configured outer contour profiles are fitted together in an interlocking manner like a puzzle to create at least one form-locking connection and/or frictional connection.

20. The press-in contact element according to claim 16, wherein in a region of the connection interface, the partial contact elements are disposed within a same layer plane.

21. The press-in contact element according to claim 16, wherein at least one of the partial contact elements includes at least one further press-in zone, wherein all of the press-in zones of the at least one partial contact element are disposed on a same layer plane which is oriented perpendicular to the press-in axes.

22. The press-in contact element according to claim 16, wherein, the partial contact elements are each configured as punched sheet metal parts or laser sheet metal parts and the press-in contact element extends within a same base sheet metal plane of the partial contact elements.

23. A method for manufacturing a press-in contact element, comprising the following steps:
a) forming at least two partial contact elements with different contours from a base material including from a strip and/or sheet metal material, each of the at least two partial contacts elements including at least one press-in zone by a cutting process and an embossing process;
b) applying a galvanic coating at least in a region of the at least one press-in zone of the at least two partial contact elements; and
c) connecting the at least two partial contact elements in a region of a connection interface to create the press-in contact element such that the at least one press-in zones formed on the at least two partial contact elements with different contours are disposed on a parallel press-in axis and in a direction of the press-in axes with a spacing distance from one another.

24. The method according to claim 23, wherein, in the method step a), a plurality of the at least two partial contact elements with different contours are respectively formed in a common continuous strip and/or sheet metal material as a sheet metal part composite, wherein each of the partial contact elements is held in the sheet metal part composite via at least one sheet metal web made of the strip and/or sheet metal material and is not singulated until after method step b) and before method step c) by severing the at least one sheet metal web.

25. The method according to claim 24, wherein the press-in zones of a plurality of the at least two partial contact elements with different contours included in the sheet metal part composite are formed such that they are disposed in a common coating region in a direction of a strip path of the continuous strip and/or sheet metal material and the galvanic coating is applied in method step b) using a coating device during a relative, continuous, movement of the sheet metal part composite and the coating device to one another in the common coating region.

26. The method according to claim 23, wherein, in the method step a), the at least two partial contact elements with different contours are formed over a respective contour section with complementarily configured outer contour profiles and, in method step c), the at least two partial contact elements are fitted together in an interlocking manner like a puzzle in the region of the complementarily configured outer contour profiles to create the connection interface as a form-locking connection and/or a frictional connection.

27. The method according to claim 23, wherein the at least two partial contact elements are connected to one another in the region of the connection interface using a material connection including a weld connection or a solder connection, by disposing the partial contact elements in a common sheet metal plane.

28. A sheet metal part composite, comprising:
a plurality of at least two partial contact elements with different contours in a common continuous strip and/or sheet metal material, wherein the partial contact elements are respectively held in the sheet metal part composite via at least one sheet metal web made of the strip and/or sheet metal material and each includes a respective at least one press-in zone, wherein the partial contact elements are disposed within the sheet metal part composite such that the respective at least one press-in zones are disposed one behind the other parallel to an edge of the strip and/or sheet metal material.

29. The sheet metal part composite according to claim 28, wherein sections of the outer contour profile of the respective at least two partial contact elements with different contours are configured complementarily to one another such that, in the singulated state due to being separated from the sheet metal part composite at the respective holding sheet metal web, the at least two partial contact elements with different contours form a press-in contact element by fitting the complementarily configured outer contour profiles together in an interlocking manner like a puzzle.

30. The sheet metal part composite according to 28, wherein the sheet metal part composite further comprises a galvanic coating at least in a region of the press-in zones disposed one behind the other parallel to the edge of the strip and/or sheet metal material.
